(19) United States
(12) Patent Application Publication
(10) Pub. No.: US 2019/0172095 A1
(43) Pub. Date: Jun. 6, 2019

(54) PROCESS AND SYSTEM FOR LOCATION BASED ADVERTISING

(71) Applicant: Diesel Media Group, LLC, Scottsdale, AZ (US)

(72) Inventor: Patrick J. Bohrman, Scottsdale, AZ (US)

(73) Assignee: Diesel Media Group, LLC, Scottsdale, AZ (US)

(21) Appl. No.: 16/208,974

(22) Filed: Dec. 4, 2018

Related U.S. Application Data
(60) Provisional application No. 62/594,832, filed on Dec. 5, 2017.

(51) Int. Cl. G06Q 30/02; G06F 16/9537; G01C 21/36

(52) U.S. Cl. CPC G06Q 30/0266; G01C 21/36; G06F 16/9537

(57) ABSTRACT

The present disclosure provides methods and systems for location based advertising which is able to use more detailed data related to when, where, and how advertising is done and who sees it, as well as providing data useful in the evaluation of the advertising. For example, in accordance with various aspects of the present disclosure, the system identifies one or more vehicles with standard routes. Route data is collected using a vehicle tracking device associated with the vehicle. Peripheral data associated with the standard route is also collected. The route data and the peripheral data are processed to output a route attribute profile which is communicated to a target business to sell white space on the vehicle for advertising.

### FIELD

The present disclosure relates generally to systems and methods for location based advertising, particularly, mobile advertising.

### BACKGROUND

Known methods of advertising, both outdoor and, to some extent, indoor, are largely based on a “shoot from the hip” approach. In this regard, advertisements are commonly placed on immobile billboards, kiosks, and other signage based on a general understanding of who might see the advertisement. The type of advertisements and the locations of the same are, at best, determined based on a very general understanding of the demographics of a geographical area (e.g., socio-economic, age, population and zip code density, etc.). At times, even these types of factors are unknown or unused, and the placement of advertisement is based on factors as simple as the number of vehicles that might drive by the advertisement based on average traffic. Very little, if any, consideration is given to the relevance of the advertisement to those that might actually observe it, and moreover, there are no mechanisms for evaluating the effectiveness or return on investment of such advertising.

With respect to outdoor advertisement, in attempts to try and increase the amount of people that see a given advertisement, vehicles (e.g., cars, trucks, etc.) may carry or otherwise be emblazoned with advertisements. As the vehicles move about, the belief is that more people will view the advertisements thereon. However, just like with the immobile advertisements noted above, little to no consideration is given to the relevance of the advertisement to those that might observe it, and there are no mechanisms for evaluating the effectiveness or return on investment of such advertising.

Accordingly, more and more, advertising expenditures are shifting away from traditional forms of immobile or mobile outdoor advertising media. As such, there is a need for methods and systems for location based advertising which is able to use more detailed data related to when, where, and how advertising is done and who sees it, as well as providing data useful in the evaluation of the advertising.

### SUMMARY OF THE INVENTION

While the ways in which the present disclosure addresses the disadvantages of the prior art will be discussed in greater detail below, in general, the present disclosure provides methods and systems for location based advertising which is able to use more detailed data related to when, where, and how advertising is done and who sees it, as well as providing data useful in the evaluation of the advertising. For example, in accordance with various aspects of the present disclosure, the system identifies one or more vehicles with standard routes. Route data is collected using a vehicle tracking device associated with the vehicle. Peripheral data associated with the standard route is also collected. The route data and the peripheral data are processed to output a route attribute profile which is communicated to a target business to sell white space on the vehicle for advertising.

### BRIEF DESCRIPTION OF THE DRAWINGS

The accompanying drawings are included to provide a further understanding of the disclosure and are incorporated in and constitute a part of this specification, illustrate embodiments of the disclosure, and together with the description serve to explain the principles of the disclosure, wherein like numerals denote like elements and wherein:

FIG. 1 is a block diagram illustrating steps in a system for mobile location based advertising in accordance with the present disclosure.

FIG. 2 is map showing standard routes of four different delivery trucks in accordance with the present disclosure.

FIG. 3 illustrates a traveling vehicle passing other vehicles and pedestrians wherein data is pulled unique devices of the users of such vehicles and from the pedestrians and then used to push advertisements to the unique devices.

### DETAILED DESCRIPTION OF THE ILLUSTRATED EMBODIMENTS

Persons skilled in the art will readily appreciate that various aspects of the present disclosure can be realized by any number of methods and systems configured to perform the intended functions. Stated differently, other methods and systems can be incorporated herein to perform the intended functions. It should also be noted that the accompanying drawing figures referred to herein are not all drawn to scale, but can be exaggerated to illustrate various aspects of the present disclosure, and in that regard, the drawing figures should not be construed as limiting.

Additionally, systems and methods disclosed herein may be described herein in terms of functional block components, optional selections and various processing steps. It should be appreciated that such functional blocks may be realized by any number of hardware and/or software components configured to perform the specified functions. For example, the systems and methods described herein may employ various integrated circuit components, e.g., memory elements, processing elements, logic elements, look-up tables, and/or the like, which may carry out a variety of functions under the control of one or more microprocessors or other control devices. Similarly, the software elements of the systems and methods may be implemented with any programming or scripting language such as C, C++, Java, COBOL, assembler, PERL, Visual Basic, SQL Stored Procedures, extensible markup language (XML), with the various algorithms being implemented with any combination of data structures, objects, processes, routines or other programming elements. Further, it should be noted that the systems and methods may employ any number of conventional techniques for data transmission, signaling, data processing, network control, and/or the like. Still further, the systems and methods could be used to detect or prevent security issues with a client-side scripting language, such as JavaScript, VBScript or the like.

Software elements of the methods and systems for mobile location based advertising as described herein may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Systems of location based advertising disclosed herein may communicate in any number of known or as yet unknown manners, such as over networks. As used herein, the term “network” is any electronic communication means which includes hardware and/or software components for communication among parties through any suitable communication channels, such as, for example, a telephone network, an extranet, an intranet, Internet, point of interaction device (e.g., point of sale device, personal digital assistant, cellular phone, kiosk, etc.), online communications, satellite communications, off-line communications, wireless communications, transponder communications, local area network (LAN), wide area network (WAN), networked or linked devices, keyboard, mouse and/or any suitable communication or data input modality.

The system may employ any number of databases in any number of configurations. Further, any databases discussed herein may be any type of database, such as relational, hierarchical, graphical, object-oriented, and/or other database configurations. Common database products that may be used to implement the databases include DB2 by IBM, various database products available from Oracle Corporation, Microsoft Access or Microsoft SQL Server by Microsoft Corporation, or any other suitable database product.

Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like.

In various embodiments, for security, databases, systems, devices, servers or other components of the methods and systems for mobile location based advertising may consist of any combination thereof at a single location or at multiple locations, wherein each database includes any of various suitable security features, such as firewalls, access codes, encryption, decryption, compression, decompression, and/or the like.

In various embodiments, the systems may employ various known or as yet unknown authentication methods to validate credentials of users, assign proper permissions, and retrieve preferences information for authorized users of the system, such as target businesses further described below. For example, such users may create accounts within the system. In this regard, an account, username, password, and the like may include any identifying indicia and codes (e.g., one or more of an authorization/access code, personal identification number (“PIN”), Internet code, other identification code, and/or the like), number, letter, symbol, digital certificate, or other identifier/indicia suitably configured to allow a user to securely access, interact with or communicate with the system.

In various embodiments, an Internet server employs an application server to manage various applications and utilities that are utilized by the system. For example, the Internet server may interact directly with the various systems and components disclosed herein (e.g., the different modules and engines). In an embodiment, the Internet server is a file server. As one skilled in the art will appreciate, in various embodiments Internet server may comprise a single physical server, multiple physical servers, multiple logical servers, etc. For example, the Internet server may include a plurality of web servers that service requests from users, and acquire and share data, etc. The system may include any number of computing platforms and databases that may be commonly found within a typical client/server, internet search provider and/or electronic commerce implementation.

Other components of the system may include, for example, registration systems, management information systems, business information systems, third-party service and data providers and the like. Each of the systems may be interconnected by a network via any method and/or device described herein, or those as yet unknown. The system, or any other components discussed herein, may further include one or more of the following: a host server or other computing systems including processors for processing digital data; a memory coupled to the processor for storing digital data; an input digitizer coupled to the processor for inputting digital data; an application program stored in memory and accessible by the processor for directing processing of digital data by the processor; a display device coupled to a processor and memory for displaying information derived from digital data processed by the processor; and a plurality of databases.

In this regard, one or more of the components of the system may be embodied as a customization of an existing system, an add-on product, upgraded software, a stand-alone system, a distributed system, a method, a data processing system, a device for data processing, a computer and/or a computer program product. Accordingly, individual system components may take the form of an entirely software embodiment, an entirely hardware embodiment, or an embodiment combining aspects of both software and hardware.

For example, in an embodiment, system hardware components (e.g., a computer) may include a processor, a memory, a communications interface, a network interface, etc. Individual system components may take the form of a computer program product on a computer-readable storage medium having computer-readable program code means embodied in the storage medium. Any suitable computer-readable storage medium may be utilized, including hard disks, CD-ROM, flash memory, optical storage devices, magnetic storage devices, and/or the like.

The system may also contemplate uses in association with various web services including software as a service or “SaaS”, object access and messaging protocols, utility computing, pervasive and individualized computing, security and identity solutions, electronic commerce, autonomic computing, commodity computing, mobility and wireless solutions, open source, biometrics, grid computing and/or mesh computing.

Users of the methods and systems herein may obtain access through “clients.” In this regard, a “client” comprises any hardware and/or software suitably configured to facilitate requesting, retrieving, sending, receiving, updating, analyzing, entering and/or modifying data. For example, in one embodiment, a client is configured to facilitate input, receipt and/or review of information relating to the user and the user's preferences. The client includes any device (e.g., personal computer) and/or software (e.g., browser applications) which communicates (in any manner discussed herein) with the system via any network discussed herein.

The system may incorporate web- and browser-based interfaces, native mobile applications, and application programming interfaces (APIs). Practitioners will appreciate that there are a number of methods for displaying data within a browser-based document. Data may be represented as standard text or within a fixed list, scrollable list, drop-down list, editable text field, fixed text field, modal, data visualization and live/real-time data updates, and/or the like. Likewise, there are a number of methods available for modifying data in a web page such as, for example, free text entry using a keyboard, selection of menu items, check boxes, option boxes, and/or the like.

Browser applications may comprise Internet browsing software installed within a computing unit or system to conduct searches for products and services, review information, conduct or initiate online transactions and/or facilitate electronic communications. These computing units or systems may take the form of a computer or set of computers, although other types of computing units or systems may be used, including laptops, notebooks, hand held computers and other mobile devices, set-top boxes, workstations, computer-servers, main frame computers, mini-computers, PC servers, pervasive computers, network sets of computers, and/or the like.

The client typically includes an operating system such as, by way of example only, Windows, OS2, UNIX, Linux, Solaris, MacOS, Android, Palm OS, iPhone OS etc.) as well as various conventional support software and drivers typically associated with computers. The client may include any suitable mobile device (e.g., a mobile device that includes short messaging service (SMS) functionality), phone, personal computer, network computer, workstation, minicomputer, mainframe or the like. The client can be in a home or business environment with access to a network. In an exemplary embodiment, access is through a network or the Internet through a commercially available web-browser software package.

Any of the communications, inputs, storage, databases or displays discussed herein may be facilitated through a web site having web pages. As used herein, a “web page” is not meant to limit the type of documents and applications that might be used to interact with the user. For example, a typical web site might include, in addition to standard HTML documents, various forms, Java applets, JavaScript, AJAX (asynchronous JavaScripti+XML), active server pages (ASP), PHP, ZEND Framework, common gateway interface scripts (CGI), extensible markup language (XML), dynamic HTML, cascading style sheets (CSS), helper applications, plug-ins, and/or the like. A server may include a web service that receives a request from a web server, the request including a URL or an IP address.

The above being noted and as described in further detail herein, the present disclosure provides a system for mobile advertising including location based advertising which is able to use more detailed data related to when, where, and how advertising is done and who sees it, as well as providing data useful in the evaluation of the advertising.

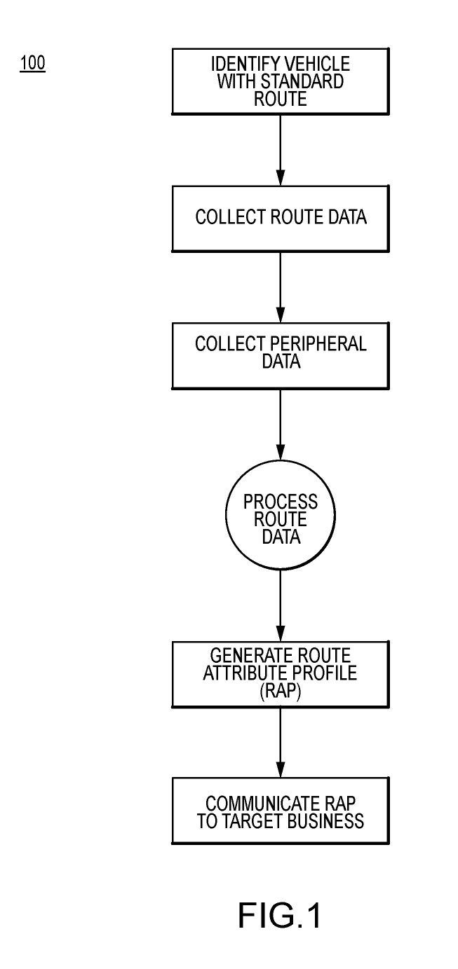

For example, with reference to the block diagram of FIG. 1, as will be described in more detail herein, a system for location based advertising 100 first identifies one or more vehicles with standard routes 102. After identifying the vehicles with the standard routes, route data is collected using a vehicle tracking device associated with the vehicle 104. Additionally, peripheral data associated with the standard route is also collected 106. The route data and the peripheral data are then processed with a processor 108 to output at least one route attribute profile 110. The route attribute profile(s) are then communicated to a target business to sell white space on the vehicle for advertising 112.

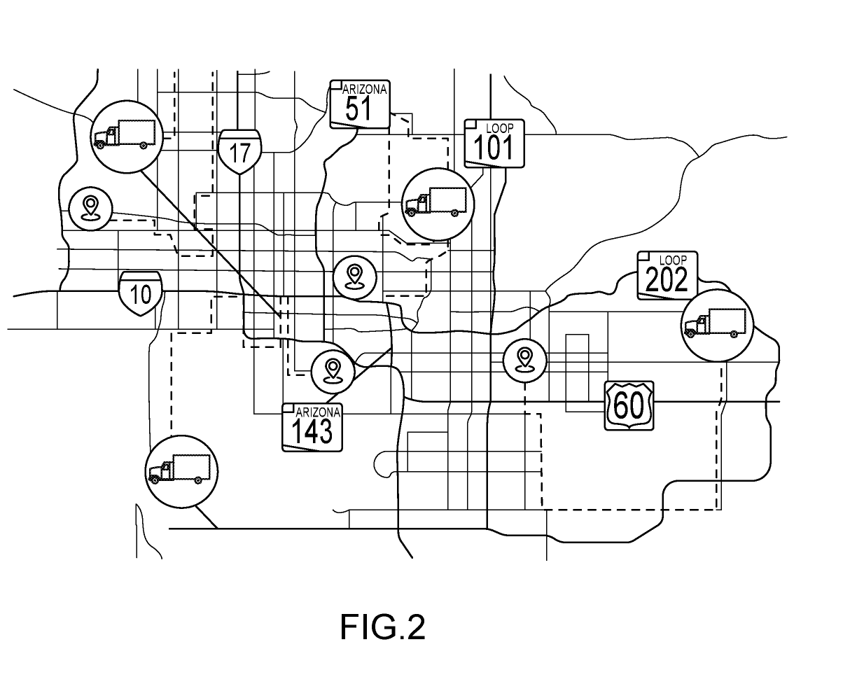

More specifically, as noted above, in accordance with various aspects of the present disclosure, the system 100 identifies one or more vehicles with a standard route or routes 102. A “standard route” is defined herein to mean a generally consistent and/or predictable route. A delivery truck with a standard route may take the same general path about a given area on particular days and/or at particular times. The route need not be identical to be “standard,” but is typically consistent enough to be predictable. For example, FIG. 2 is a map showing four different standard routes of typical “box trucks” superimposed on a map.

Once at least one vehicle with a standard route has been identified, route data relating to the standard route is collected 102. As used herein, “route data” includes any data that may be relevant to the route taken which may also be useful in connection with determining advertising strategies, the demographics of the people and businesses likely to observe the advertising, and similar data. Examples of route data include the location of the route, the date and time the route begins and ends, stops or “waypoints” along the route and the time spent at those waypoints, the distance of the route, and other similar data. The route data may further comprise the amount of time it takes the vehicle to go between waypoints, and the time of day the vehicle passes specific waypoints.

Route data can be collected using known or as yet unknown vehicle tracking devices associated with the vehicle. For example, exemplary vehicle tracking devices include a GPS device such as a solar powered GPS transmitters such as the GT1100 manufactured and sold by ORBCOMM™. Route data may be pulled from online reporting tools and then transmitted to the system via an API.

In accordance with various aspects of the present disclosure, the system 100 may also collect various peripheral data associated with standard route and route data 106. For example, demographics of standard routes such as whether the route passes through residential, commercial or industrial areas, city or highway, as well as any combination of these. Similarly, demographics relating to socio-economic backgrounds, rural versus urban, ethnic, religious and other factors of the people likely to observe the advertising may be collected. In accordance with various aspects of the present disclosure, the system may also note changes in various peripheral data along the standard route, such as changes in the peripheral data from waypoint to waypoint or between waypoints.

Peripheral data can be collected or derived from a variety of known or as yet unknown sources, including Bluetooth and WIFI tracking of mobile devices to better understand nearby consumer's habits such as, by way of non-limiting example, directional information, and the ability to differentiate a retail shopper versus another driver in traffic. Additionally, peripheral data may include tracking movement type and related data (e.g., direction, speed, walking vs. driving, etc.) as well as the same as it relates to the proximity to the advertisement. The same enables better understanding of predictive behaviors, travel patterns, time of day and location density. Additionally, collecting peripheral data in conjunction with GPS reporting of the technology can have interconnectivity via the internet of things, enabling the driver (carrier) to choose a higher visibility route ensuring a greater number of impressions amidst travel.

Known peripheral data may also include third party historical traffic data suppliers who can offer demographic statistics based on, for example, by zip code, by city block, and/or based on time of day. This known data can be meshed with unknown data sources such as those derived from Beacon based HTTPS URL's broadcast from Eddystone URL Devices. Beacon based proximity data may be used for marketing objectives but may also obtain user information from devices which allow the release of the user profiles information within permissible third-party applications.

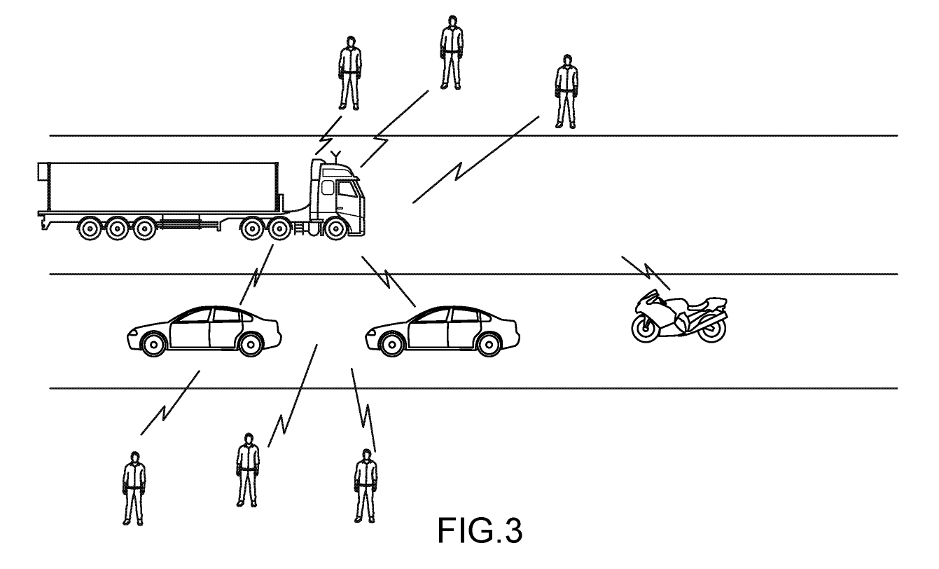

Alternatively (or in addition to) and with reference briefly to FIG. 3, collecting peripheral data as set forth above, the peripheral data may be created based on pulling data (e.g., via NFC, beacon and similar technologies) from unique individual devices such as cell phones, tablets, laptops and other devices and technology and “wearables” that are proximate a peripheral data receiver associated with the vehicle along the standard route. As such, as the vehicles travel along the standard route (or alternatively, non-standard routes), passing other vehicles and pedestrians, data may be pulled from the users of such vehicles and from the pedestrians and then may be used to push advertisements to the unique individual devices proximate the peripheral data receiver based on the peripheral data collected. Additionally, where a vehicle has video technology capabilities, advertising on the vehicle itself may vary based on the data pulled from individuals proximate the vehicle.

In accordance with various aspects of the present disclosure, the system can store the route data and peripheral data on a storage medium such as those disclosed above, as well as other storage mediums not specifically disclosed herein.

In accordance with various aspects of the present disclosure and referring back to FIG. 1, the system 100 processes the route data and the peripheral data with a processor to output a route attribute profile 110. The route attribute profile may be a summary of the all or selected portions of the route data and the peripheral data presented in such a way as to allow a business to understand aspects of the route such as the demographics and number of people likely to see an advertisement on the vehicle while traveling the standard route. The route attribute profile may include data such as an approximate number of people likely to observe the vehicle and a demographic associated with such people. The route attribute profiles may be periodically re-evaluated to determine whether there have been changes to the route data and peripheral data which would change the route attribute profiles.

In accordance with some aspects of the present disclosure, the route attribute profiles may be used as a basis for evaluating the standard routes. For example, the standard routes illustrated in FIG. 1 may be evaluated and then ranked on a scale from basic to premium.

Advertising charges associated with such routes may then be adjusted accordingly. For example, guaranteeing a set number of monthly exposure hours within high population density urban areas might increase a ranking and corresponding cost. Similarly, a target business's return on investment can be compared and evaluated in light of the route attribute profile and the cost associated with advertising on a particular standard route.

For example, with reference to FIG. 2 two of the routes illustrated are described. As illustrated, one route may comprise a vehicle is on an unspecified, non-repeated or “unique” route of pick-up and delivery which begins with loading products at a known supplier such as a home improvement store. Examples of such products picked up include commercial washers and dryers. The products traveling the first route are delivered to residential neighborhoods. As such, data collected can be gathered from customers entering and exiting the home improvement store while the truck is being loaded in front of the store. The vehicle then exits a commercial district and begins multiple deliveries within residential neighborhoods and being observed by consumers such as home owners and contractors proximate the homes in the residential area. This vehicle will carry an advertisement specific to such homeowners or homes services contractors and the beacons will push content via directed towards the same market.

On a second route a vehicle may be traveling on a specified and repeated route with consistently timed deliveries to retail based customers on a standard schedule (e.g., five days per week). The vehicle departs from a commercial warehouse with product and travels through a high density urban metro area and proceeds to park and load/unload product in front of commercial retail strip centers and malls throughout the city. These business to business commercial transactions involve a high-density route with a wide array of demographic consumer exposure. The vehicle will push timely beacon notifications dictated by a predetermined algorithm based on gathered route information. For example, a special lunch promotion message from a local restaurant may be sent while unloading in front of a retail mall food court during the lunch hour. The vehicles advertisement will be based on wider consumer base like a beverage preferred by a wider audience. Although the routes are different and the marketing “mechanism of action” (truck-side signage and beacons) is the same, the advertiser and algorithm will adjust to maximize impressions per said audience, and the advertising charges can be based on the same.

In accordance with various aspects of the present disclosure, the system 100 may communicate the route attribute profile to a target business to sell white space on the vehicle for advertising 112. As used herein, a “target business” is any business that may have a need for advertising services, whether or not previously known to an operator of the system. In accordance with various aspects, the target business may be able select from multiple routes displayed over a route map such as disclosed in FIG. 1. In accordance with various aspects of the present disclosure, the system itself may use the route attribute profile to first determine a preferred target business.

Alternatively, in accordance with various aspects of the present disclosure, a target business may request a preferred route attribute profile from a listing of a variety of exemplary preferred route attribute profiles presented to the business, and the system then accesses a database of known route attribute profiles to provide a match to the preferred route attribute profile for the target business.

In accordance with various aspects of the present disclosure, the system may track the vehicle or vehicles along the standard route(s) and create tracking data. As used herein, “tracking data” may include, among other things, various objective data about the standard route such as where the vehicle stopped, how long it took the vehicle to run the standard route, where the vehicle was parked on the standard route, and where and when the vehicle was parked off the standard route. In some embodiments, the tracking may take place in real time. In accordance with various aspects of the present disclosure, the system may include an application, for example, a web-based application, that allows target businesses to login to the system to view the tracking data. Similar to the comparison and evaluation of the route attribute profiles noted above, the tracking data may similarly be useful in calculating a return on investment for the target business. For example, the ability to login and observe an individual active vehicle advertising campaign at any time via GPS may provide some proof of performance of each individual advertising campaign.

In accordance with various aspects of the present disclosure, the system may also provide the ability to monetize white space on vehicles during “down-time.” For example, the system may determine one or more periods of time when a vehicle is not travelling on the standard route. Then, when an event with a desired demographic is scheduled to occur, such as a sporting event, concert, festival, or the like, an advertisement based on the desired demographic is selected and associated with the vehicle and the vehicle is parked proximate the event during the period of time when the vehicle is not travelling the standard route. The advertising may include signage attached to or proximate the vehicle, electronic push notifications such as those within a geofence or otherwise similar to the pull/push process of FIG. 3 (but with a parked vehicle), or any other now known or as yet unknown advertising that may be benefit when used in conjunction with systems such as those disclosed herein.

Finally, it will be apparent to those skilled in the art that various modifications and variations can be made in the present disclosure without departing from the spirit and scope of the disclosure. Thus, it is intended that the present disclosure cover the modifications and variations of this disclosure provided they come within the scope of the appended claims and their equivalents.

Likewise, numerous characteristics and advantages have been set forth in the preceding description, including various alternatives together with details of the structure and function of the methods and systems described herein. The disclosure is intended as illustrative only and as such is not intended to be exhaustive. It will be evident to those skilled in the art that various modifications may be made, especially in matters of order, process, structure, elements, components, and arrangement including combinations of the same within the principles of the disclosure, to the full extent indicated by the broad, general meaning of the terms in which the appended claims are expressed. To the extent that these various modifications do not depart from the spirit and scope of the appended claims, they are intended to be encompassed therein.

What is claimed is:

1. A computer implemented system for mobile advertising, comprising the steps of:
identifying a vehicle with a standard route;
collecting route data using a vehicle tracking device associated with the vehicle;
collecting peripheral data associated with the standard route;
storing the route data and peripheral data on a storage medium;
processing the route data and the peripheral data with a processor to output a route attribute profile; and
communicating the route attribute profile to a target business to sell white space on the vehicle for advertising.

2. The computer implemented system for mobile advertising of claim 1, wherein the vehicle tracking device is a GPS device.

3. The computer implemented system for mobile advertising of claim 1, further comprising the step of using the route attribute profile to determine the target business.

4. The computer implemented system for mobile advertising of claim 1, wherein the target business requests a preferred route attribute profile and the system accesses a database of known route attribute profiles to provide a match to the preferred route attribute profile.

5. The computer implemented system for mobile advertising of claim 1, wherein the route data comprises waypoints along the standard route, an amount of time it takes the vehicle to go between waypoints, and a time of day the vehicle passes the waypoints.

6. The computer implemented system for mobile advertising of claim 1, wherein the peripheral data comprises demographics of the standard route.

7. The computer implemented system for mobile advertising of claim 1, wherein the peripheral data is retrieved from a database.

8. The computer implemented system for mobile advertising of claim 5, wherein the peripheral data comprises demographics between the waypoints along the standard route.

9. The computer implemented system for mobile advertising of claim 1, wherein the peripheral data is created by determining at least one of: whether portions between waypoints on the standard route are residential, commercial or industrial areas, whether portions between waypoints on the standard route are city or highway, and socioeconomic status of people likely to observe the vehicle at the portions between waypoints.

10. The computer implemented system for mobile advertising of claim 1, wherein the peripheral data is created based on pulling data from unique individual devices proximate a peripheral data receiver associated with the vehicle along the standard route.

11. The computer implemented system for mobile advertising of claim 10, wherein the peripheral data is used to push advertisement to the unique individual devices proximate the peripheral data receiver.

12. The computer implemented system for mobile advertising of claim 1, wherein the route attribute profile comprises an approximate number of people likely to observe the vehicle and a demographic associated with the people.

13. The computer implemented system for mobile advertising of claim 1, further comprising the step of tracking the vehicle along the standard route to create tracking data.

14. The computer implemented system for mobile advertising of claim 13, wherein the tracking data includes at least one of reporting where the vehicle stopped on the standard route, how long it took the vehicle to run the standard route, where the vehicle was parked on the standard route, and where the vehicle was parked off the standard route.

15. The computer implemented system for mobile advertising of claim 13, wherein the tracking is done in real time.

16. The computer implemented system for mobile advertising of claim 13, wherein the target business can login to the system to view the tracking data.

17. The computer implemented system for mobile advertising of claim 1, further comprising the steps of periodically re-evaluating the route attribute profile.

18. The computer implemented system for mobile advertising of claim 1, further comprising the step of evaluating a plurality of standard routes and ranking them on a scale from basic to premium.

19. The computer implemented system for mobile advertising of claim 1, further comprising the steps of:
determining a period of time when the vehicle is not travelling on the standard route;
selecting an event with a desired demographic;
selecting an advertisement based on the desired demographic;
associating the advertisement with the vehicle; and
parking the vehicle proximate the event during the period of time.

20. The computer implemented system for mobile advertising of claim 19, wherein the advertisement comprises push notifications within a geofence.
